(19) United States
(12) Patent Application Publication
(10) Pub. No.: US 2022/0026582 A1
(43) Pub. Date: Jan. 27, 2022

(54) SATELLITE SIGNAL RECEIVING DEVICE, CONTROL METHOD OF SATELLITE SIGNAL RECEIVING DEVICE, PROGRAMS, AND ELECTRONIC DEVICE

(71) Applicant: SEIKO EPSON CORPORATION, Tokyo (JP)

(72) Inventor: Eiji KINOSHITA, Matsumoto-shi (JP)

(21) Appl. No.: 17/380,887

(22) Filed: Jul. 20, 2021

(30) Foreign Application Priority Data
Jul. 22, 2020 (JP) 2020-125763

(51) Int. Cl. G01S 19/34; H04W 52/02

(52) U.S. Cl. CPC G01S 19/34; H04W 52/028

(57) ABSTRACT

A satellite signal receiving device includes a first RF receiving circuit receiving a first satellite signal from a first GNSS, a second RF receiving circuit receiving a second satellite signal from a second GNSS, a baseband processing circuit processing the first satellite signal and the second satellite signal, and one or more processors configured to control operations of the first RF receiving circuit, the second RF receiving circuit, and the baseband processing circuit, in which the one or more processors are configured to execute performing reception processing of the first satellite signal, acquiring a first reception state including a processing result of the reception processing of the first satellite signal, determining processing capacity of reception processing of the second satellite signal depending on the first reception state, and performing the reception processing of the second satellite signal with the processing capacity.

The present application is based on, and claims priority from JP Application Serial Number 2020-125763, filed Jul. 22, 2020, the disclosure of which is hereby incorporated by reference herein in its entirety.

### BACKGROUND

### 1. Technical Field

The present disclosure relates to a satellite signal receiving device, a control method of the satellite signal receiving device, a program, and an electronic device.

### 2. Related Art

A global positioning system (GPS) is widely known as a positioning system that uses signals for positioning and is used in portable telephone devices, car navigation devices, or the like. In GPS, positions of a plurality of GPS satellites, pseudo distances from each GPS satellite to a receiving device, and the like are obtained by using the time measured by the GPS receiving device, and the position of the GPS is calculated based on the obtained information.

JP-A-2013-228250 discloses a GPS receiving device performing an intermittent position calculating operation that repeats a period in which the position calculating operation is executed and a period in which the position calculating operation is not executed, in order to reduce power consumption. Specifically, JP-A-2013-228250 discloses a receiving device that includes at least a continuous drive mode, in which a radio frequency (RF) receiving circuit section that receives a satellite signal from a satellite for positioning and a baseband processing circuit section that processes the signal received by the RF receiving circuit section are continuously driven, and a multi-stage intermittent mode, in which the baseband processing circuit section is intermittently driven and the RF receiving circuit section is intermittently driven during the drive period, and switches the drive modes depending on the reception intensity of satellite signals.

In recent years, a positioning system is often collectively referred to as a global navigation satellite system (GNSS). The GPS described above is also a type of GNSS, and other types such as Beidou, GLONASS, and Galileo are known.

JP-A-2013-228250 discloses a receiving device that uses one type of GNSS, such as GPS, but in recent years, there has been a demand for a receiving device that supports so-called multi-GNSS, in which a plurality of types of GNSS are used in combination.

However, in the multi-GNSS, signals can be acquired from more satellites, which is expected to improve performance such as improved positioning accuracy and expanded positioning capable area, but there is a problem of increasing power consumption.

### SUMMARY

A satellite signal receiving device according to an application example of the present disclosure includes: a first RF receiving circuit receiving a first satellite signal from a first GNSS; a second RF receiving circuit receiving a second satellite signal from a second GNSS; a baseband processing circuit processing the first satellite signal and the second satellite signal; and one or more processors configured to control operations of the first RF receiving circuit, the second RF receiving circuit, and the baseband processing circuit, in which the one or more processors are configured to execute performing reception processing of the first satellite signal, acquiring a first reception state including a processing result of the reception processing of the first satellite signal, determining processing capacity of reception processing of the second satellite signal depending on the first reception state, and performing the reception processing of the second satellite signal with the processing capacity.

A control method of a satellite signal receiving device according to another application example of the present disclosure is a control method of a satellite signal receiving device that includes a first RF receiving circuit receiving a first satellite signal from a first GNSS, a second RF receiving circuit receiving a second satellite signal from a second GNSS, and a baseband processing circuit processing the first satellite signal and the second satellite signal, the control method includes: a step of causing the first RF receiving circuit to perform reception processing of receiving the first satellite signal from the first GNSS; a step of acquiring a first reception state including a processing result of the reception processing of the first satellite signal; a step of determining processing capacity of reception processing of the second satellite signal depending on the first reception state; and a step of causing the second RF receiving circuit to perform the reception processing of receiving the second satellite signal from the second GNSS with the processing capacity.

A non-transitory computer-readable storage medium according to still another application example of the present disclosure stores a program that causes one or more processors that are coupled to a first RF receiving circuit receiving a first satellite signal from a first GNSS, a second RF receiving circuit receiving a second satellite signal from a second GNSS, and a baseband processing circuit processing the first satellite signal and the second satellite signal, the program includes: causing the first RF receiving circuit to perform reception processing of receiving the first satellite signal from the first GNSS; acquiring a first reception state including a processing result of the reception processing of the first satellite signal; determining processing capacity of reception processing of the second satellite signal depending on the first reception state; and causing the second RF receiving circuit to perform the reception processing of receiving the second satellite signal from the second GNSS with the processing capacity.

An electronic device according to still another application example of the present disclosure includes the satellite signal receiving device according to the application example of the present disclosure.

### BRIEF DESCRIPTION OF THE DRAWINGS

FIG. 1 is a block diagram illustrating a functional configuration of a satellite signal receiving device according to an embodiment.

FIG. 2 is a diagram illustrating an example of a hardware configuration of a baseband processing control section illustrated in FIG. 1.

FIG. 3 is a diagram illustrating a specification of satellite navigation information of GPS.

FIG. 4 is a diagram illustrating a specification of satellite navigation information D1 of Beidou.

FIG. 5 is a diagram illustrating a difference between transmission speeds of the satellite navigation information of GPS and the satellite navigation information D1 of Beidou, and a transmission speed of satellite navigation information D2.

FIG. 6 is a flowchart describing a reception positioning operation of the satellite signal receiving device illustrated in FIG. 1.

FIG. 7 is a table illustrating an example of a relationship between indices, in which each factor constituting a first reception state is defined as an index, and scores representing the quality of the indices, and is an example of an index calculation table stored in a storage section.

FIG. 8 is a table illustrating an example of a determination reference of the first reception state and is an example of an index calculation table stored in the storage section.

FIG. 9 is a flowchart describing intermittent drive control processing illustrated in FIG. 6.

FIG. 10 is a flowchart describing an intermittent drive control for positioning by a first GNSS, which is illustrated in FIG. 9.

FIG. 11 is a flowchart describing an intermittent drive control for positioning by a second GNSS, which is illustrated in FIG. 9.

FIG. 12 is a flowchart describing an intermittent drive control for positioning by the second GNSS, which is illustrated in FIG. 9.

FIG. 13 is a block diagram illustrating a circuit configuration of an electronic timepiece which is an electronic device according to the embodiment.

### DESCRIPTION OF EXEMPLARY EMBODIMENTS

Hereinafter, preferred embodiments of a satellite signal receiving device, a control method of the satellite signal receiving device, a program, and an electronic device according to the present disclosure will be described in detail with reference to the accompanying drawings.

### 1. Satellite Signal Receiving Device

A satellite signal receiving device according to an embodiment will be described.

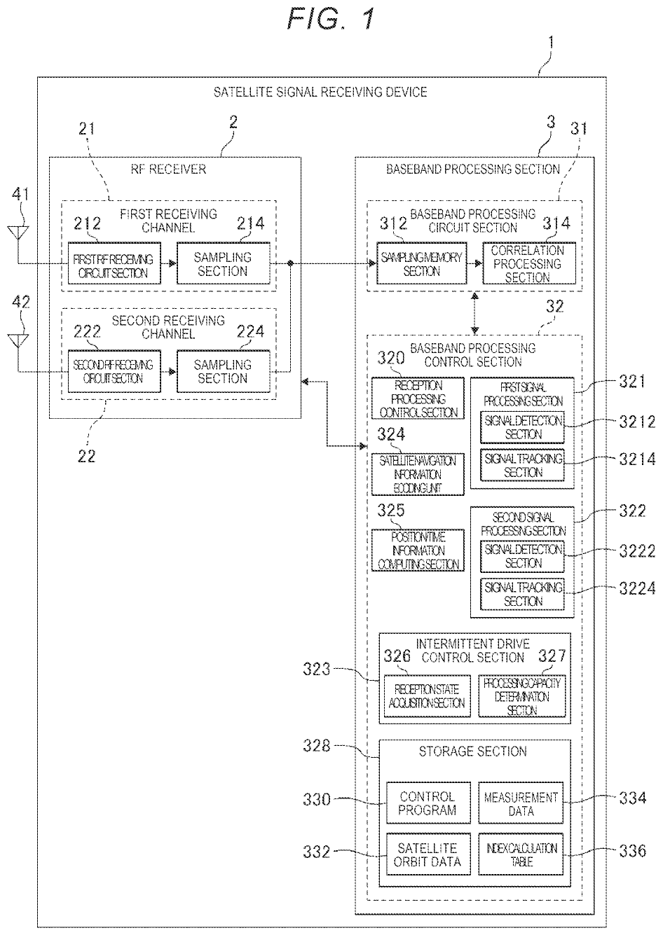

FIG. 1 is a block diagram illustrating a functional configuration of a satellite signal receiving device according to an embodiment.

The satellite signal receiving device 1 illustrated in FIG. 1 is a device corresponding to a multi-GNSS. The multi-GNSS is a usage mode in which a plurality of types of GNSS are used in combination. Examples of GNSS include GPS, Beidou, GLONASS, Galileo, and the like. As an example, the satellite signal receiving device 1 according to the present embodiment uses any two of the above examples in combination. Hereinafter, the first one of GNSS is referred to as a “first GNSS”, a satellite that belongs to the first GNSS is referred to as a “first GNSS satellite”, and a signal carried on a radio wave transmitted from the first GNSS satellite is referred to as a “first satellite signal”. Further, the second one of GNSS is referred to as a “second GNSS”, a satellite that belongs to the second GNSS is referred to as a “second GNSS satellite”, and a signal carried on a radio wave transmitted from the second GNSS satellite is referred to as a “second satellite signal”.

The satellite signal receiving device 1 illustrated in FIG. 1 includes an RF receiver 2, a baseband processing section 3, and antennas 41 and 42.

### 1.1. RF Receiver

The RF receiver 2 illustrated in FIG. 1 receives radio waves from a GNSS satellite by using antennas 41 and 42 and outputs received signals. Specifically, the RF receiver 2 illustrated in FIG. 1 includes a first receiving channel 21 that receives radio waves from a first GNSS satellite by using the antenna 41 and a second receiving channel 22 that receives radio waves from a second GNSS satellite by using the antenna 42.

The first receiving channel 21 illustrated in FIG. 1 includes a first RF receiving circuit section 212 coupled to the antenna 41 and a sampling section 214 coupled to the first RF receiving circuit section 212.

The second receiving channel 22 illustrated in FIG. 1 includes a second RF receiving circuit section 222 coupled to the antenna 42 and a sampling section 224 coupled to the second RF receiving circuit section 222.

The first RF receiving circuit section 212 and the second RF receiving circuit section 222 are receiving circuits of RF signals and receive radio waves from the GNSS satellite. The circuit configurations of the first RF receiving circuit section 212 and the second RF receiving circuit section 222 include, for example, an amplifier circuit that amplifies the RF signal output from the antennas 41 and 42, a bandpass filter that removes, from RF signals, components other than a frequency bandwidth of the satellite signals, a mixer circuit that mixes local oscillation signals and converts the RF signals into intermediate frequency bandwidth signals, or the like.

The sampling sections 214 and 224 are provided with an analog-to-digital converter and the like. The received signals output from the first RF receiving circuit section 212 and the second RF receiving circuit section 222 are converted into digital signals by the sampling sections 214 and 224 at a predetermined sampling cycle. The converted digital signals are output to the baseband processing section 3.

The RF receiver 2 may include three or more receiving channels depending on the number of types of GNSS received by the satellite signal receiving device 1. Further, the satellite signal receiving device 1 may be provided with three or more antennas accordingly.

However, it is not essential that the number of types of GNSS supported by the satellite signal receiving device 1 and the number of receiving channels are the same. For example, when one receiving channel can receive radio waves from two or more types of GNSS satellite, the number of receiving channels may be smaller than the number of types of GNSS.

### 1.2. Baseband Processing Section

The baseband processing section 3 illustrated in FIG. 1 captures and tracks a satellite signal by performing processing operations such as carrier removal or correlation computation with respect to the received signal output from the RF receiver 2. The time or position is calculated by using the time data, the satellite orbit data, and the like which are extracted from the satellite signal.

The baseband processing section 3 illustrated in FIG. 1 includes a baseband processing circuit section 31 and a baseband processing control section 32 which is a control section.

### 1.2.1. Baseband Processing Circuit Section

The baseband processing circuit section 31 includes a sampling memory section 312 and a correlation processing section 314.

The sampling memory section 312 stores the received signal output from the RF receiver 2. In the sampling memory section 312, a dedicated area may be secured for each GNSS, or the same area may be shared by a plurality of types of GNSS.

The correlation processing section 314 computes a correlation value between the received signal and a replica code stored in the sampling memory section 312.

### 1.2.2. Baseband Processing Control Section

The baseband processing control section 32 includes a reception processing control section 320, a first signal processing section 321, a second signal processing section 322, an intermittent drive control section 323, a satellite navigation information decoding section 324, and a position/time information computing section 325, and a storage section 328.

The reception processing control section 320 controls the operations of the RF receiver 2 and the baseband processing circuit section 31 to execute the reception processing of the satellite signal and positioning processing.

The first signal processing section 321 includes a signal detection section 3212 and a signal tracking section 3214.

The signal detection section 3212 controls the operations of the first RF receiving circuit section 212, the sampling section 214, and the sampling memory section 312 to receive the radio waves from the first GNSS satellite and stores the received signal in the sampling memory section 312. After that, the signal detection section 3212 controls the operation of the correlation processing section 314 to compute a correlation value between the received signal and the replica code stored in the sampling memory section 312, and detection processing (search processing) for detecting the first satellite signal is executed. The detection processing is executed until a frequency range, which is targeted by the detection processing, is ended.

The signal tracking section 3214 controls the operations of the first RF receiving circuit section 212, the sampling section 214, the sampling memory section 312, and the correlation processing section 314 to execute tracking processing for tracking the detected first satellite signal.

The second signal processing section 322 includes a signal detection section 3222 and a signal tracking section 3224.

The signal detection section 3222 controls the operations of the second RF receiving circuit section 222, the sampling section 224, and the sampling memory section 312 to receive the radio waves from the second GNSS satellite and stores the received signal in the sampling memory section 312. After that, the signal detection section 3222 controls the operation of the correlation processing section 314 to compute a correlation value between the received signal and the replica code stored in the sampling memory section 312, and detection processing (search processing) for detecting the second satellite signal is executed. The detection processing is executed until a frequency range, which is targeted by the detection processing, is ended.

The signal tracking section 3224 controls the operations of the second RF receiving circuit section 222, the sampling section 224, the sampling memory section 312, and the correlation processing section 314 to execute tracking processing for tracking the detected second satellite signal.

The RF receiver 2 and the baseband processing section 3 may be housed in one semiconductor chip, may be housed in individual semiconductor chips, or are each constituted by a plurality of semiconductor chips.

The intermittent drive control section 323 controls the RF receiver 2 and the baseband processing circuit section 31 to be intermittently driven. The intermittent drive control section 323 illustrated in FIG. 1 includes a reception state acquisition section 326 and a processing capacity determination section 327. Each section of the intermittent drive control section 323 will be described in detail later.

The satellite navigation information decoding section 324 executes decoding processing for decoding data such as satellite navigation information or code information from the satellite signal that is being tracked.

The position/time information computing section 325 executes the positioning processing for acquiring time information or position information by computing based on the decoded data.

The storage section 328 stores various data and the like in addition to a control program 330 for implementing various functions of the baseband processing control section 32. As illustrated in FIG. 1, examples of the main data stored in the storage section 328 include satellite orbit data 332 such as an ephemeris or an almanac, which will be described later, measurement data 334 required for search processing or tracking processing, an index calculation table 336 for calculating an index used for determining the first reception state, which will be described later, and the like.

Of these, the measurement data 334 is various quantities related to the GNSS satellite that is being tracked, and examples thereof include a code phase, a reception frequency, and the like.

### 1.2.4. Hardware Configuration

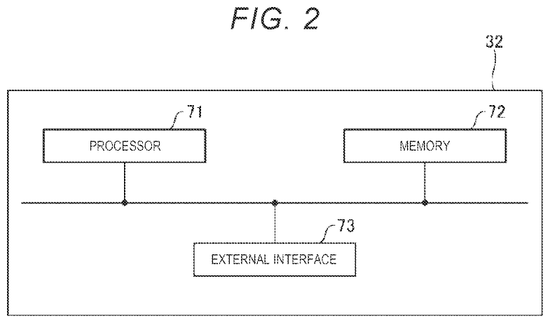

FIG. 2 is a diagram illustrating an example of a hardware configuration of a baseband processing control section 32 illustrated in FIG. 1. The operation of the baseband processing control section 32 is implemented by the hardware configuration as illustrated in FIG. 2.

The baseband processing control section 32 includes hardware of a processor 71, a memory 72, and an external interface 73, which are coupled to each other by an internal bus or a dedicated communication line. For the processor 71, for example, a central processing unit (CPU) or the like is used. For the memory 72, a random access memory (RAM), a read only memory (ROM), flash memory, or the like is used. The external interface 73 may use cables or may use wireless.

The processor 71 reads a program stored in the memory 72 and executes the program to implement the operation of the baseband processing control section 32. A part or all of the operations of the baseband processing control section 32 may be implemented by hardware such as a large scale integration (LSI), an application specific integrated circuit (ASIC), or a field-programmable gate array (FPGA), or may be implemented by the collaboration of software and hardware.

### 2. Specification Example of Satellite Navigation Information

Next, the specifications of the satellite navigation information will be described. A satellite signal is carried on the radio waves transmitted from the GNSS satellite. The satellite signal mainly includes information (satellite navigation information) related to the satellite orbit of the GNSS satellite. Hereinafter, as an example, the specifications of the satellite navigation information of GPS and Beidou will be described.

### 2.1. Satellite Navigation Information of GPS

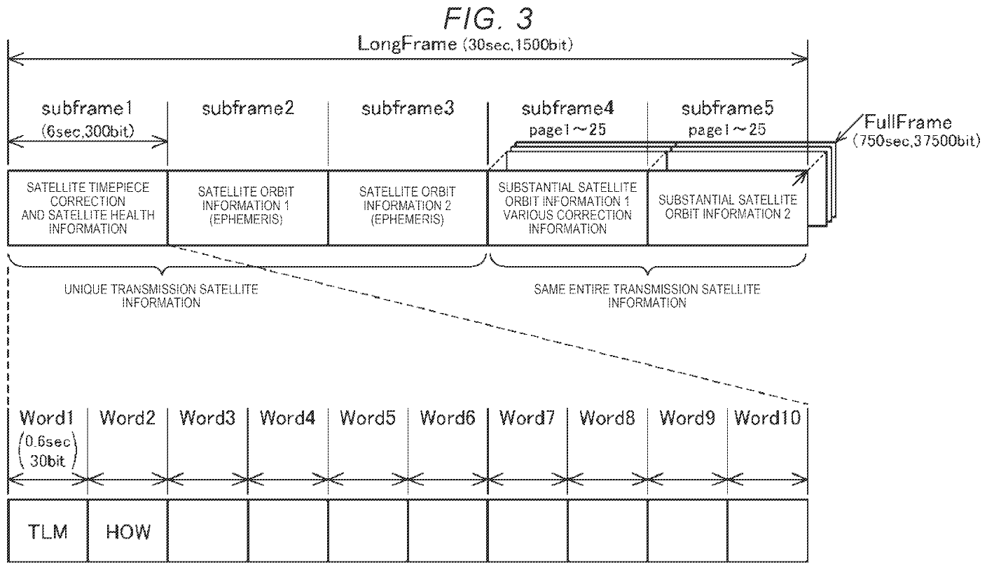

FIG. 3 is a diagram illustrating the specification of the satellite navigation information of GPS.

As illustrated in FIG. 3, the satellite navigation information of GPS is constituted by data in which a long frame having a total number of bits of 1500 bits is defined as one unit. Each long frame is divided into five subframes 1 to 5, each having 300 bits. The data of one subframe is transmitted from the GPS satellite in 6 seconds. Therefore, one long frame of data is transmitted from GPS satellites in 30 seconds.

The subframe 1 includes satellite timepiece correction information, satellite health information, and the like.

The subframe 2 includes satellite orbit information 1, and the subframe 2 includes satellite orbit information 2. The satellite orbit information 1 and 2 are called the ephemeris and include detailed orbit information of each GPS satellite. The ephemeris is transmitted as unique information from the GPS satellite that is being tracked. By acquiring the ephemeris from the GPS satellite that is being tracked, the current position of the GPS satellite that is being tracked can be calculated so that it is possible to perform the positioning processing. Note that, a valid date is set on the ephemeris, and it is necessary to acquire the ephemeris on a regular basis in order to continuously perform the positioning processing.

The subframe 4 includes substantial satellite orbit information 1 and various correction information, and the subframe includes substantial satellite orbit information 2. The substantial satellite orbit information 1 and 2 are called the almanac and include the substantial orbit information of all GPS satellites. The almanac is transmitted as the same information from all GPS satellites that are being tracked. The data in the subframes 4 and 5 is a part of the data divided into a plurality of long frames, and all of these data constitute a unit called a full frame.

The subframes 1 to 5 include data of words 1 to 10 by 30 bits from the front. Of these, the word 1 stores telemetry word (TLM) data. Further, the word 2 stores hand over word (HOW) data. The TLM data and the HOW data are used for acquiring date information and time information.

### 2.2. Satellite Navigation Information of Beidou

Beidou has two types of satellite navigation information, D1 and D2. D1 is transmitted from a non-geostationary satellite and D2 is transmitted from a geostationary satellite.

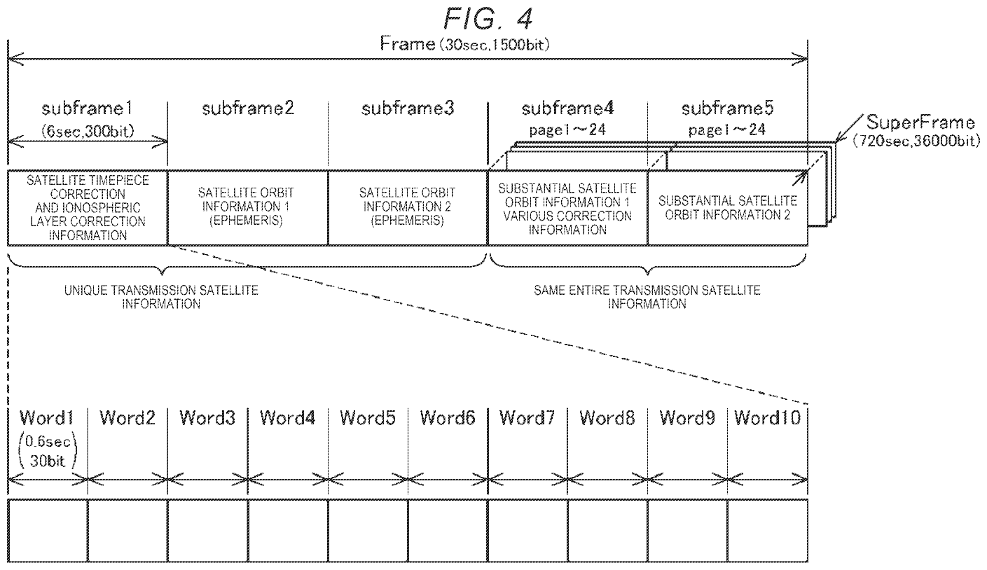

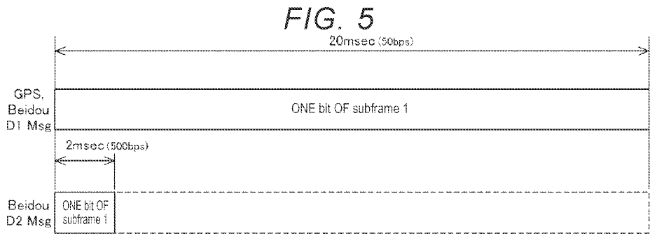

FIG. 4 is a diagram illustrating a specification of satellite navigation information D1 of Beidou. FIG. 5 is a diagram illustrating a difference between transmission speeds of the satellite navigation information of GPS and the satellite navigation information D1 of Beidou, and a transmission speed of satellite navigation information D2.

As illustrated in FIG. 4, the satellite navigation information D1 of Beidou is constituted by data in which a frame having a total number of bits of 1500 bits is defined as one unit. The specification of the satellite navigation information D1 is almost the same as the specification of the satellite navigation information of GPS, except that the number of pages of the subframes 4 and 5 is smaller than that of the GPS.

As illustrated in FIG. 5, there is a difference that the transmission speed of the satellite navigation information of GPS and the transmission speed of the satellite navigation information D2 of Beidou are 10 times faster than that of the satellite navigation information D1. Therefore, the time representing one bit of the satellite navigation information D2 is 1/10 of the time representing one bit of the satellite navigation information D1.

### 3. Reception Positioning Operation of Satellite Signal Receiving Device

Next, a reception positioning operation of the satellite signal receiving device 1 illustrated in FIG. 1 will be described.

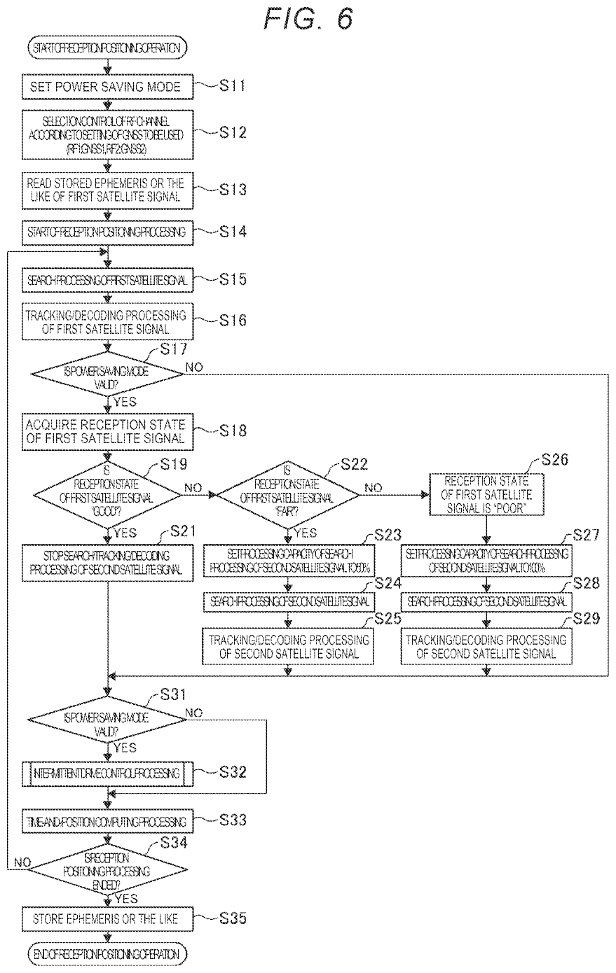

FIG. 6 is a flowchart describing a reception positioning operation of the satellite signal receiving device 1 illustrated in FIG. 1.

### 3.1. Processing Capacity Control of Second Satellite Signal Depending on First Reception State

In step S11, a reception processing control section 320 of the baseband processing control section 32 sets whether or not the RF receiver 2 and the baseband processing circuit section 31 are operated in a power saving mode. In the present embodiment, the power saving mode is set to be selected.

In step S12, the reception processing control section 320 performs selection control of a receiving RF channel with respect to the RF receiver 2 according to the setting of the GNSS to be used. In the present embodiment, two are used, the first receiving channel 21 and the second receiving channel 22. The first receiving channel 21 receives radio waves from the first GNSS satellite, and the second receiving channel 22 receives radio waves from the second GNSS satellite.

In step S13, when the satellite navigation information such as the valid ephemeris of the first GNSS is stored in the storage section 328, the reception processing control section 320 reads the information. The satellite navigation information may be acquired at the end of the previous reception operation or may be received from a base station or the like.

In step S14, the reception positioning processing of the first satellite signal is started by the first signal processing section 321. Specifically, first, in step S15, the signal detection section 3212 performs search processing for detecting the first satellite signal. At this time, when the valid ephemeris is stored, search processing for detecting the first satellite signal is performed by using the ephemeris. On the other hand, when the valid ephemeris is not stored but the almanac is stored in the sampling memory section 312, search processing for detecting the first GNSS satellite is performed by using the almanac. Further, when neither the ephemeris nor the almanac is stored, search processing for detecting the first GNSS satellite in a predetermined order is performed.

In step S16, the signal tracking section 3214 performs tracking processing for tracking the detected first satellite signal. The satellite navigation information decoding section 324 performs decoding processing for decoding the satellite navigation information from the first satellite signal being tracked. The satellite navigation information obtained by the decoding processing is stored as satellite orbit data 332 in the storage section 328 described above.

In step S17, it is determined whether or not the power saving mode set in step S11 is valid at that time. When it is not valid, the process proceeds to step S31. On the other hand, when the power saving mode is valid, the process proceeds to step S18.

In step S18, the reception state acquisition section 326 of the intermittent drive control section 323 acquires a reception state (first reception state) of the first satellite signal. The first reception state refers to the quality of a factor representing the reception or positioning state of the first satellite signal. Specifically, factors of the number of tracking satellites of the first GNSS, a reception signal intensity index of the first satellite signal, a reception satellite disposition index of the first GNSS, a movement state of the satellite signal receiving device 1, a positioning state based on the first satellite signal, or the like, are listed, and the first reception state described above may include information indicating the quality of at least one of these factors. In addition to these factors, that is, factors based on the processing results from the search processing, the tracking processing, and the decoding processing, the first reception state may include, for example, factors based on information received from a base station or the like.

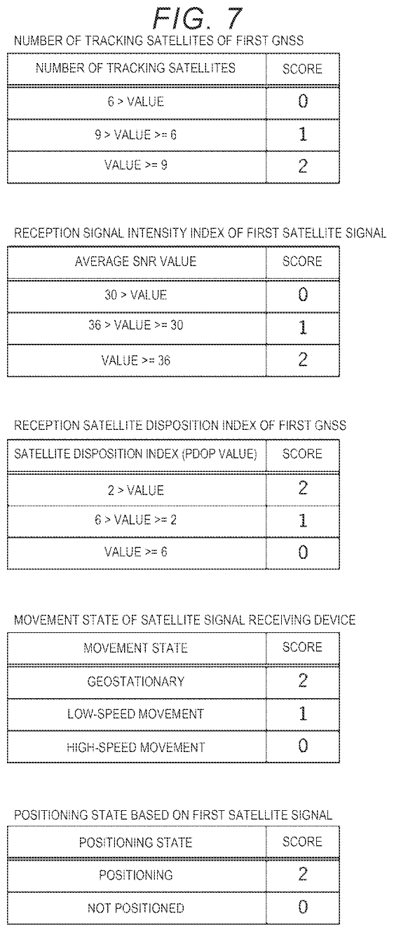

FIG. 7 is a table illustrating an example of a relationship between indices, in which each factor constituting the first reception state is defined as an index, and scores representing the quality of the indices, and is an example of an index calculation table 336 stored in the storage section 328 described above. By summing the scores of each index, the first reception state can be quantitatively evaluated and used as a reference for determination in steps S19 and S22 described later.

The number of tracking satellites of the first GNSS is the number of satellites of the first GNSS satellite tracked by the signal tracking section 3214. When the number of satellites being tracked is less than 6, the score for the index becomes zero. When the number of satellites being tracked is equal to or greater than 6 and less than 9, the score for the index becomes one. Further, when the number of satellites being tracked is equal to or greater than nine, the score of the index becomes 2.

The reception signal intensity index of the first satellite signal is an average signal-to-noise ratio (average SNR value) of the first satellite signal. When the average SNR value is less than 30, the score for the index becomes zero. When the average SNR value is equal to or greater than 30 and less than 36, the score for the index becomes one. Further, when the average SNR value is equal to or greater than 36, the score of the index becomes two.

The reception satellite disposition index of the first GNSS is a position dilution of precision (PDOP) value representing the quality of the disposition of the first GNSS satellite. When the PDOP value is less than two, the score for the index becomes two. When the PDOP value is equal to or greater than two and less than 6, the score of the index becomes one. Further, when the PDOP value is equal to or greater than 6, the score of the index becomes zero. Note that, when the index cannot be calculated, the score of the index becomes zero.

The movement state of the satellite signal receiving device 1 is calculated based on a frequency change due to the Doppler effect of the first satellite signal being tracked. When the movement state is a geostationary state, the score of the index becomes two. When the movement state is a low-speed movement state, the score of the index becomes one. Further, when the movement state is the high-speed movement state, the score of the index becomes zero. Note that, when the index cannot be calculated, the score of the index becomes zero.

The positioning state based on the first satellite signal is the presence or absence of positioning based on the first satellite signal. When positioning, the score of the index becomes two. When not positioned, the score of the index becomes zero.

In step S19, the processing capacity determination section 327 of the intermittent drive control section 323 determines the processing capacity for the reception processing of the second satellite signal depending on the reception state (first reception state) of the first satellite signal. The first reception state can be quantitatively evaluated by using the index as described above. Therefore, in step S19, the quality of the first reception state is determined based on the total score of the indices described above.

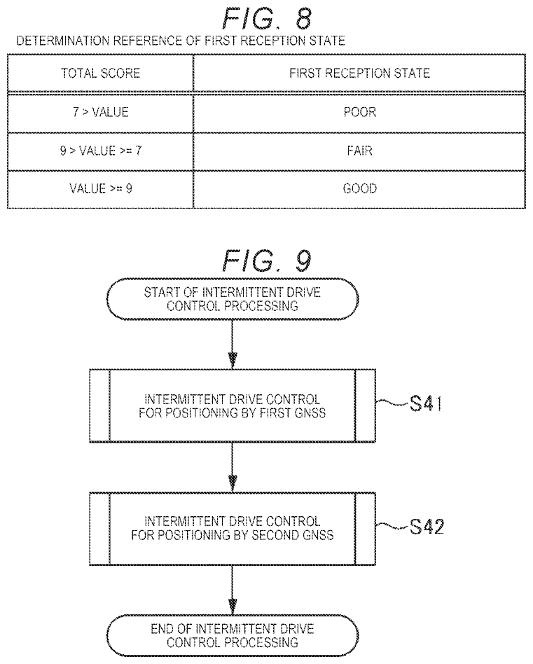

FIG. 8 is a table illustrating an example of the determination reference of the first reception state and is an example of the index calculation table 336 stored in the storage section 328 described above.

When the total score of the indices constituting the first reception state is less than 7, the first reception state is determined to be “poor”. When the total score is equal to or greater than 7 and less than 9, the first reception state is determined to be “fair”. Further, when the total score is equal to or greater than 9, the first reception state is determined to be “good”.

Therefore, in step S19, when it is determined that the first reception state is “good”, the process proceeds to step S21. In step S21, the reception processing such as the search processing, tracking processing, and decoding processing of the second satellite signal is stopped. As a result, the power consumption of the RF receiver 2 and the baseband processing section 3 can be reduced. Instead of stopping the reception processing of the second satellite signal in step S21, the processing capacity thereof may be set to be lower than that of the reception processing in step S23 described later. Further, only the search processing of the second satellite signal may be stopped, and the tracking processing and the decoding processing may be performed. In this case, the power consumption can be reduced by stopping the search processing in which the power consumption is relatively large.

When the first reception state is determined to be “good” in this way, sufficient positioning performance can be obtained with the first GNSS alone. Therefore, it is possible to stop the positioning by the second GNSS without significantly deteriorating the positioning performance. As a result, the power consumption of the satellite signal receiving device 1 can be reduced.

In step S19, when it is determined that the first reception state is other than “good”, the process proceeds to step S22. In step S22, it is determined whether or not the first reception state is “fair”. When it is determined to be “fair”, the process proceeds to step S23. In step S23, the processing capacity of the reception processing, for example, the search processing of the second satellite signal is set to 50% with respect to the maximum capacity. The processing capacity refers to a processing capacity when searching for measurement data 334 such as a code phase and reception frequency included in the second satellite signal. Specifically, the processing capacity includes a sensitivity range for performing the search processing, power for performing the search processing, and the like, and it is sufficient that at least one of the processing capacities is included.

Of these, the sensitivity range, in which the search processing is performed, is a setting of how much signal intensity is to be searched, for example, is set based on the fact that it is often more appropriate to search for a strong second satellite signal in a short time than to search for a weak second satellite signal over time. Power consumption can be reduced by shortening the time required to search for the second satellite signal.

On the other hand, power for performing the search processing is a setting of how much the search processing is to be performed in a unit time. For example, by increasing the power, the target range can be searched faster. Therefore, the second satellite signal can be detected faster, but the power consumption is increased. On the contrary, by reducing the power, the time for detecting the second satellite signal becomes longer, but the power consumption becomes smaller.

The processing capacity set in step S23 is not limited to 50% and may be higher than the processing capacity in step S21 described above.

In steps S24 and S25, the reception processing of the second satellite signal is performed with the processing capacity determined in step S23. Specifically, in step S24, the signal detection section 3222 performs the search processing for detecting the second satellite signal with the processing capacity set in step S23. In step S25, the signal tracking section 3224 performs the tracking processing for tracking the detected second satellite signal. The satellite navigation information decoding section 324 performs the decoding processing for decoding the satellite navigation information from the second satellite signal being tracked. The satellite navigation information obtained by the decoding processing is stored as satellite orbit data 332 in the storage section 328 described above. Instead of the search processing, the tracking processing may be performed with the processing capacity described above, or both the search processing and the tracking processing may be performed with the processing capacity described above. In the present embodiment, at least one of the processing capacity of the search processing and the processing capacity of the tracking processing is referred to as a “processing capacity of reception processing”.

When the first reception state is determined to be “fair” in step S22 in this way, the positioning performance maybe slightly insufficient only with the first GNSS. Therefore, by adding the positioning by the second GNSS, the positioning performance by the multi-GNSS can be improved. At this time, by reducing the processing capacity of the search processing of the second satellite signal to 50%, it is possible to simultaneously achieve a reduction in power consumption.

On the other hand, in step S22, when it is determined that the first reception state is not “fair”, the process proceeds to step S26. In step S26, it is determined that the first reception state is “poor”. After that, the process proceeds to step S27. In step S27, the processing capacity of the search processing of the second satellite signal is set to 100%. The processing capacity in step S27 is not limited to 100% and may be higher than the processing capacity in step S23 described above.

In steps S28 and S29, the reception processing of the second satellite signal is performed with the processing capacity determined in step S27. Specifically, in step S28, the signal detection section 3222 performs the search processing for detecting the second satellite signal of the second GNSS. At this time, the search processing for detecting the second satellite signal is performed with the processing capacity set in step S27. In step S29, the signal tracking section 3224 performs the tracking processing for tracking the detected second satellite signal. The satellite navigation information decoding section 324 performs the decoding processing for decoding the satellite navigation information from the second satellite signal being tracked. The satellite navigation information obtained by the decoding processing is stored as satellite orbit data 332 in the storage section 328 described above. Instead of the search processing, the tracking processing may be performed with the processing capacity described above, or both the search processing and the tracking processing may be performed with the processing capacity described above.

When the first reception state is determined to be “poor” in this way, the positioning performance is insufficient only with the first GNSS. Therefore, by adding the positioning by the second GNSS, the positioning performance by the multi-GNSS can be ensured. After that, the process proceeds to step S31.

### 3.2. Intermittent Drive Control

In step S31, it is again determined whether or not the power saving mode set in step S11 is valid at that time. When it is not valid, the process proceeds to step S33. On the other hand, when the power saving mode is valid, the process proceeds to step S32.

In step S32, the intermittent drive control section 323 of the baseband processing control section 32 executes the intermittent drive control processing. In the intermittent drive control processing, the first RF receiving circuit section 212, the second RF receiving circuit section 222, and the baseband processing circuit section 31 are intermittently driven. The duty ratio in the intermittent drive is controlled to be changed depending on the first reception state. As a result, the power consumption can be reduced without deteriorating the positioning performance.

FIG. 9 is a flowchart describing the intermittent drive control processing illustrated in FIG. 6.

In step S41, as will be described later, the intermittent drive processing for positioning by the first GNSS is performed. As a result, it is possible to reduce the power consumption in the positioning processing by the first GNSS.

In step S42, as will be described later, the intermittent drive processing for positioning by the second GNSS is performed. As a result, it is possible to reduce the power consumption in the positioning processing by the second GNSS.

3.2.1. Intermittent Drive Control for Positioning by First GNSS (step S41)

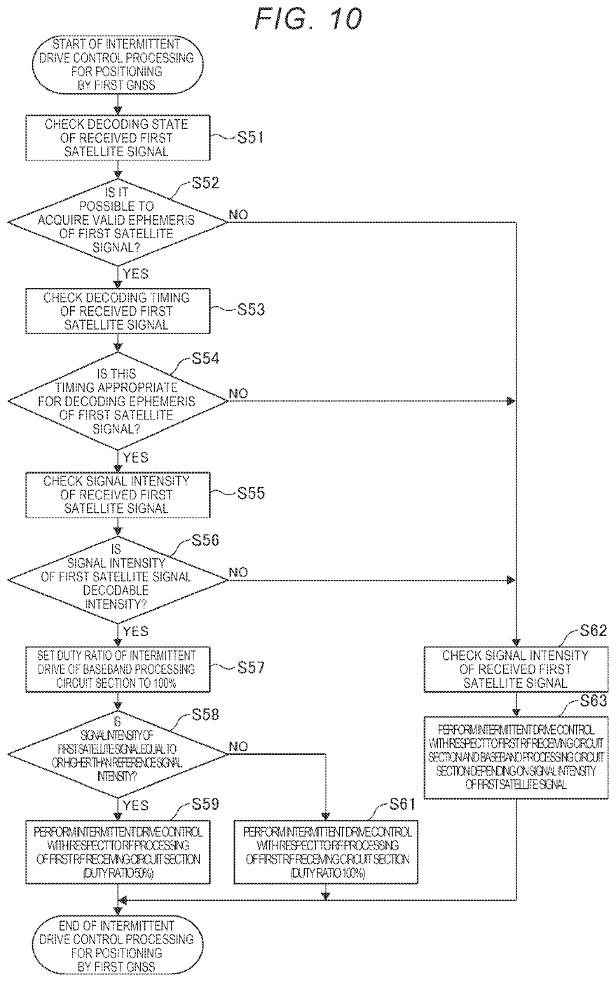

FIG. 10 is a flowchart describing an intermittent drive control for positioning by the first GNSS, which is illustrated in FIG. 9.

In step S51 illustrated in FIG. 10, the state of the decoding processing of the received first satellite signal is checked. Subsequently, in step S52, it is determined whether or not the valid ephemeris of the first satellite signal can be acquired. When the valid ephemeris is acquired, the decoding timing of the received first satellite signal is checked in step S53. Thereafter, the process proceeds to step S54. On the other hand, when the valid ephemeris is not acquired, the process proceeds to step S62, which will be described later.

In step S54, as a result of the check in step S53, it is determined whether or not the timing is appropriate for decoding the ephemeris. When the timing is appropriate for decoding the ephemeris, the signal intensity of the received first satellite signal is checked in step S55. Thereafter, the process proceeds to step S56. On the other hand, when the timing is not appropriate for decoding the ephemeris, for example, when it is the timing to decode a subframe other than the subframe including the ephemeris, the process proceeds to step S62 described later.

In step S56, as a result of the checking in step S55, it is determined whether or not the signal intensity of the first satellite signal is the decodable intensity. The decodable intensity refers to the signal intensity capable of performing the decoding processing for the satellite navigation information of the received first satellite signal. When the signal intensity of the first satellite signal is the decodable intensity, the duty ratio of the intermittent drive of the baseband processing circuit section 31 is set to 100% in step S57. Thereby, the decoding processing of the received first satellite signal can be performed. After that, the process proceeds to step S58. On the other hand, when the signal intensity of the first satellite signal is less than the decodable intensity, the decoding processing cannot be performed, so the process proceeds to step S62, which will be described later.

Therefore, in step S58 and subsequent steps in which the decoding processing needs to be performed, the intermittent drive control of the RF processing is performed with the duty ratio of the intermittent drive of the baseband processing set to, for example, 100%. The duty ratio is a ratio of an ON period with respect to the entire period of the intermittent drive.

On the other hand, in step S62 and subsequent steps described later, since it is not necessary to perform the decoding processing, the intermittent drive control is performed in both the RF processing and the baseband processing.

In step S58, it is determined whether or not the signal intensity of the first satellite signal is equal to or higher than the reference signal intensity. The reference signal intensity refers to a signal intensity that serves as a threshold value for switching the duty ratio of the intermittent drive control in steps S59 and S61, and may be defined in advance. When the signal intensity of the first satellite signal is equal to or higher than the reference signal intensity, in step S59, the intermittent drive control with respect to the RF processing of the first satellite signal by the first RF receiving circuit section 212 is performed. At this time, since the signal intensity is equal to or higher than the reference signal intensity, the duty ratio is set to 50% as an example. Specifically, when the time of one bit length determined depending on the transmission speed of satellite navigation information is 20 msec, the intermittent drive control is performed so as to repeat ON and OFF every other one msec in a section of 20 msec. As a result, the actual signal intensity is halved, but bit-unit information can be acquired so that the decoding processing can be performed. The duty ratio is not limited to 50% but may be more than 0% and less than the duty ratio in step S61 described later.

On the other hand, when the signal intensity of the first satellite signal is less than the reference signal intensity, in step S61, the intermittent drive control with respect to the RF processing of the first satellite signal by the first RF receiving circuit section 212 is performed. At this time, since the signal intensity is less than the reference signal intensity, the duty ratio is set to 100% as an example.

In contrast to this, at the start of step S62, since the valid ephemeris of the first satellite signal is not acquired, the decoding processing of the first satellite signal cannot be performed. Therefore, in step S62, the received signal intensity of the received first satellite signal is checked. After that, in step S63, since it is not necessary to consider performing the decoding processing, the intermittent drive control is performed in both the RF processing and the baseband processing. Specifically, the intermittent drive control is performed with respect to the first RF receiving circuit section 212 and the baseband processing circuit section 31 so as to change the duty ratio of the intermittent drive depending on the signal intensity of the received first satellite signal.

In the intermittent drive control in step S63, as an example, the first RF receiving circuit section 212 and the baseband processing circuit section 31 may be intermittently driven with the same duty ratio. Specifically, for example, the duty ratio may be changed from 10% to 90% depending on the reception signal intensity of the first satellite signal. When the reception signal intensity is relatively high, the duty ratio may be reduced in this range, and when the reception signal intensity is relatively low, the duty ratio may be increased in this range. As a result, power saving can be achieved in accordance with the duty ratio.

A state during the ON period of the first RF receiving circuit section 212 is a state where power is supplied from the power supply to the first RF receiving circuit section 212. In this state, the first RF receiving circuit section 212 performs circuit operations such as amplifying the RF signal received by the antenna 41, down-converting to an intermediate frequency signal, and cutting unnecessary frequency bandwidth components. During the ON period of the first RF receiving circuit section 212, the sampling section 214 may also be operated accordingly.

On the other hand, a state during the OFF period of the first RF receiving circuit section 212 is a state where power is not supplied to the first RF receiving circuit section 212. In this state, the above operation is not performed. During the OFF period of the first RF receiving circuit section 212, the operation of the sampling section 214 may also be stopped accordingly.

Further, during the ON period of the baseband processing circuit section 31, the reception positioning processing of the first satellite signal is performed. On the other hand, during the OFF period of the baseband processing circuit section 31, the reception positioning processing of the first satellite signal is not performed.

3.2.2. Intermittent Drive Control for Positioning by Second GNSS (step S42)

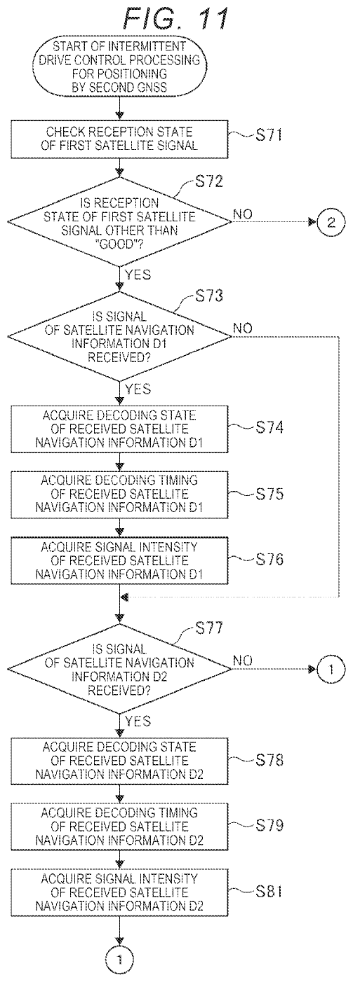

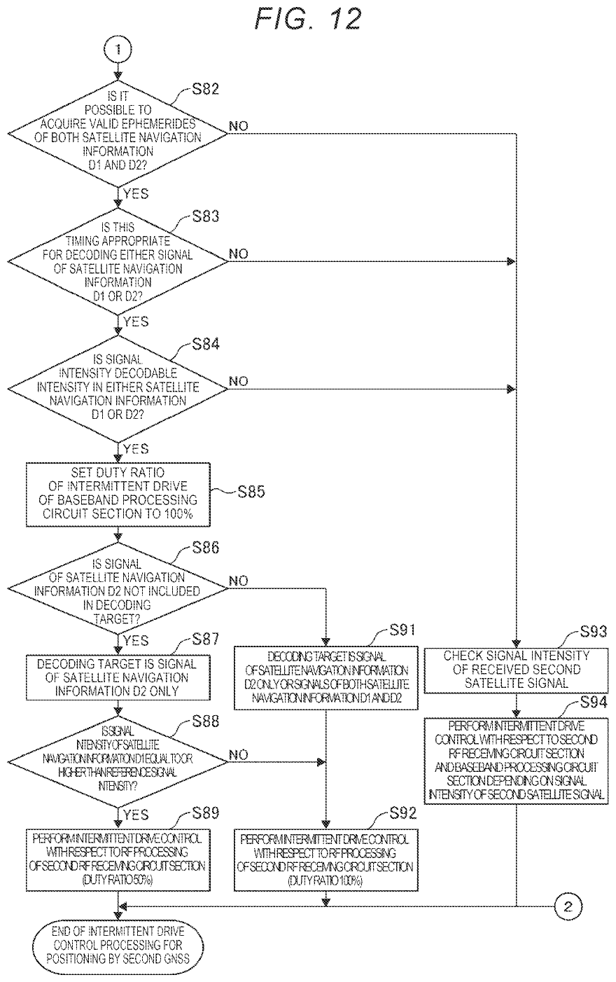

Each of FIGS. 11 and 12 is a flowchart for describing the intermittent drive control for positioning by the second GNSS illustrated in FIG. 9.

In step S71 illustrated in FIG. 11, the reception state (first reception state) of the first satellite signal is acquired in the same manner as in step S18 illustrated in FIG. 6. In step S72, when it is determined that the first reception state is other than “good”, that is, “fair” or “poor” in view of the tables illustrated in FIGS. 7 and 8, the process proceeds to step S73. On the other hand, when it is determined that the first reception state is “good”, the intermittent drive control for the positioning by the second GNSS is ended as illustrated in FIG. 12. Instead of stopping the entire positioning operation by the second GNSS, only the search processing may be stopped and the tracking processing and the decoding processing may be performed. In this case, the power consumption can be reduced by stopping the search processing in which the power consumption is relatively large.

In step S73 and subsequent steps, a case where the second satellite signal includes two types of satellite navigation information, D1 and D2, will be described in particular. As an example, the above-mentioned Beidou has two types of satellite navigation information, D1 transmitted from a non-geostationary satellite and D2 transmitted from a geostationary satellite. When there is only one type of satellite navigation information, it may be performed in the same manner as the intermittent drive control for positioning by the first GNSS described above.

In step S73, it is determined whether or not the second satellite signal including the satellite navigation information D1 is received. When it is received, in step S74, the state of the decoding processing of the satellite navigation information D1 included in the received second satellite signal is acquired. The state of the decoding processing means whether or not the valid ephemeris of the satellite navigation information D1 can be acquired. Subsequently, in step S75, the decoding timing of the received second satellite signal is acquired. Subsequently, in step S76, the signal intensity of the received second satellite signal is acquired. After that, the process proceeds to step S77. On the other hand, when the second satellite signal including the satellite navigation information D1 is not received in step S73 described above, the process proceeds to step S77.

In step S77, it is determined whether or not the second satellite signal including the satellite navigation information D2 is received. When it is received, in step S78, the state of the decoding processing of the satellite navigation information D2 included in the received second satellite signal is acquired. The state of the decoding processing means whether or not the valid ephemeris of the satellite navigation information D2 can be acquired. Subsequently, in step S79, the decoding timing of the received second satellite signal is acquired. Subsequently, in step S81, the signal intensity of the received second satellite signal is acquired. After that, the process proceeds to step S82 illustrated in FIG. 12. On the other hand, when the second satellite signal including the satellite navigation information D2 is not received in step S77 described above, the process proceeds to step S82.

In step S82, it is determined whether or not the valid ephemerides can be acquired in both the satellite navigation information D1 and D2. When the valid ephemeris is acquired, the process proceeds to step S83. On the other hand, when the valid ephemeris cannot be acquired for at least one of the satellite navigation information D1 and D2, the process proceeds to step S93, which will be described later.

In step S83, it is determined whether or not the timing is appropriate for decoding the ephemeris in either the signal including the satellite navigation information D1 or the signal including the satellite navigation information D2. When the timing is appropriate for decoding the ephemeris, the process proceeds to step S84. On the other hand, when the timing is not appropriate for decoding the ephemeris, the process proceeds to step S93, which will be described later.

In step S84, it is determined whether or not the signal intensity is the decodable intensity in either the signal including the satellite navigation information D1 or the signal including the satellite navigation information D2. When the signal intensity is decodable intensity, the process proceeds to step S85. On the other hand, when the signal intensity is less than the decodable intensity, the decoding processing cannot be performed, so the process proceeds to step S93 described later.

In step S85, the duty ratio of the intermittent drive of the baseband processing circuit section 31 is set to, for example, 100%. Thereby, the decoding processing can be performed for at least one of the signal including the received satellite navigation information D1 and the signal including the satellite navigation information D2. After that, the process proceeds to step S86.

In this way, in step S86 and subsequent steps in which the decoding processing needs to be performed, the intermittent drive control of the RF processing is performed with the duty ratio of the intermittent drive of the baseband processing set to, for example, 100%.

On the other hand, in step S93 and subsequent steps described later, since it is not necessary to perform the decoding processing, the intermittent drive control is performed in both the RF processing and the baseband processing.

In step S86, it is determined whether or not the signal including the satellite navigation information D2 is included in a target of the decoding processing. When it is not included in the target of the decoding processing, it is checked in step S87 that the target of the decoding processing is a signal including only the satellite navigation information D1. In step S88, it is determined whether or not the signal intensity of the signal including the satellite navigation information D1 is equal to or higher than the reference signal intensity. The reference signal intensity refers to a signal intensity that serves as a threshold value for switching the duty ratio of the intermittent drive control in steps S89 and S92 described later and may be defined in advance. When the signal intensity of the signal including the satellite navigation information D1 is equal to or higher than the reference signal intensity, in step S89, the intermittent drive control with respect to the RF processing of the second satellite signal by the second RF receiving circuit section 222 is performed. At this time, since the signal intensity is equal to or higher than the reference signal intensity, the duty ratio is set to 50% as an example. Specifically, when the time representing one bit length determined depending on the transmission speed of the satellite navigation information D1 is 20 msec, the intermittent drive control is performed so as to repeat ON and OFF every other one msec in a section of 20 msec. As a result, the actual signal intensity is halved, but bit-unit information can be acquired so that the decoding processing can be performed. The duty ratio is not limited to 50% but may be more than 0% and less than the duty ratio in step S92 described later.

On the other hand, in step S86, when the signal including the satellite navigation information D2 is included in the target of the decoding processing, in step S91, it is checked whether the target of the decoding processing is only the signal including the satellite navigation information D2 or the signal including both the satellite navigation information D1 and D2. After that, the process proceeds to step S92.

In step S92, the intermittent drive control for the RF processing of the second satellite signal by the second RF receiving circuit section 222 is performed. At this time, the duty ratio is set to 100% as an example. The reason for setting in this way is that the transmission speed of the above-mentioned satellite navigation information D2 is faster than the transmission speed of the satellite navigation information D1. Specifically, in the case of Beidou, for example, since the transmission speed of the satellite navigation information D2 is 500 bps, the time representing one bit length is as short as 2 msec. Therefore, when the intermittent drive control is performed every other one msec as in step S89 described above, there is a problem that the signal output from the second RF receiving circuit section 222 becomes very weak. Therefore, in step S86 described above, when the signal including the satellite navigation information D2 is included in the target of the decoding processing, in step S92, it is preferable to set the duty ratio of the intermittent drive control with respect to the second RF receiving circuit section 222 to a value larger than the duty ratio in step S89, for example, 100%.

In step S88 described above, even when the signal intensity of the signal including the satellite navigation information D1 is less than the reference signal intensity, the process proceeds to step S92. In this case, since the signal intensity of the signal including the satellite navigation information D1 is less than the reference signal intensity, similarly, it is preferable to set the duty ratio of the intermittent drive control with respect to the second RF receiving circuit section 222 to a value larger than the duty ratio in step S89, for example, 100%.

Although step S88 may be provided as needed and may be omitted, it is preferable to provide step S88 from the viewpoint of avoiding a significant decrease in positioning performance.

As described above, when the signal including the satellite navigation information D2 is not included in the target of the decoding processing, the power consumption is reduced by performing the intermittent drive control with respect to the second RF receiving circuit section 222. In the case of Beidou, since the signal including the satellite navigation information D2 is transmitted from the geostationary satellite, the receivable area is limited. Therefore, the power consumption can be effectively reduced in the area where the signal including the satellite navigation information D2 cannot be received.

Therefore, the flow in step S86 and subsequent steps can solve the above problem by itself. That is, when the satellite signal receiving device 1 is frequently moved between the area where the signal including the satellite navigation information D2 can be received and the area where the signal including the satellite navigation information D2 cannot be received, by switching the duty ratio of the intermittent drive control as described above, it is possible to effectively reduce the power consumption.

Next, step S93 branched in steps S82, S83, and S84 will be described. At the start of step S93, since it is a situation that the valid ephemeris cannot be acquired from either the satellite navigation information D1 or D2 of the second GNSS, the decoding processing of the second satellite signal cannot be performed. Therefore, in step S93, the received signal intensity of the received second satellite signal is checked. After that, in step S94, since it is not necessary to consider performing the decoding processing, the intermittent drive control is performed in both the RF processing and the baseband processing. Specifically, the intermittent drive control is performed with respect to the second RF receiving circuit section 222 and the baseband processing circuit section 31 so as to change the duty ratio of the intermittent drive depending on the received signal intensity of the second satellite signal being received.

In the intermittent drive control in step S94, the second RF receiving circuit section 222 and the baseband processing circuit section 31 may be intermittently driven in the same manner as the intermittent drive control in step S63 described above. For example, the duty ratio may be changed from 10% to 90% depending on the reception signal intensity of the second satellite signal. When the reception signal intensity is relatively high, the duty ratio may be reduced in this range, and when the reception signal intensity is relatively low, the duty ratio may be increased in this range. As a result, power saving can be achieved in accordance with the duty ratio. As described above, power saving can be achieved in accordance with the duty ratio.

A state during the ON period of the second RF receiving circuit section 222 is a state where power is supplied from the power supply to the second RF receiving circuit section 222. In this state, the second RF receiving circuit section 222 performs circuit operations such as amplifying the RF signal received by the antenna 42, down-converting to an intermediate frequency signal, and cutting unnecessary frequency bandwidth components. During the ON period of the second RF receiving circuit section 222, the sampling section 224 may also be operated accordingly.

On the other hand, a state during the OFF period of the second RF receiving circuit section 222 is a state where power is not supplied to the second RF receiving circuit section 222. In this state, the above operation is not performed. During the OFF period of the second RF receiving circuit section 222, the operation of the sampling section 224 may also be stopped accordingly.

Further, during the ON period of the baseband processing circuit section 31, the reception positioning processing of the second satellite signal is performed. On the other hand, during the OFF period of the baseband processing circuit section 31, the reception positioning processing of the second satellite signal is not performed.

### 3.3. Time/Position Computing

In step S33 illustrated in FIG. 6, the position/time information computing section 325 uses the measurement data 334 and the satellite orbit data 332 to perform the positioning processing by applying a known method. In the positioning processing, position information and time information are calculated by acquiring the ephemeris from three or more satellites as a result of the decoding processing. At this time, the first GNSS satellite and the second GNSS satellite can be combined. As a result, signals can be acquired from more satellites so that positioning accuracy can be improved or the positioning capable area can be expanded.

In step S34, it is determined whether or not to end the reception positioning processing. When continuing the reception positioning processing, the process returns to step S15. On the other hand, when the reception positioning processing is ended, in step S35, the satellite orbit information such as the ephemeris held at that time is stored in the storage section 328 as the satellite orbit data 332. After that, the reception positioning operation is ended.

The operation of the satellite signal receiving device 1 has been described above. However, the satellite signal receiving device 1 may be a 2GNSS type corresponding to the first GNSS and the second GNSS described above, or may be a type corresponding to the third GNSS, the fourth GNSS, . . . . In that case, according to the number of the corresponding GNSS, the RF receiving channel in the RF receiver 2 may be increased.

As described above, there are various types of GNSS, but the combination thereof is not particularly limited. As an example, examples include a combination in which the first GNSS is GPS and the second GNSS is Beidou, or vice versa, a combination in which the first GNSS is GPS and the second GNSS is GLONASS, or vice versa, a combination in which the first GNSS is GLONASS and the second GNSS is Beidou, or vice versa, a combination in which the first GNSS is GPS+Beidou and the second GNSS is GLONASS, or vice versa, or the like.

Furthermore, although it is not a global navigation satellite system, a satellite-based augmentation system (SBAS) or a regional navigation satellite system (RNSS) such as a quasi-zenith satellite can also be used as the first GNSS or the second GNSS.

As described above, the satellite signal receiving device 1 according to the present embodiment includes the first RF receiving circuit section 212, the second RF receiving circuit section 222, the baseband processing circuit section 31, and the baseband processing control section 32 that is the control section. Of these, the first RF receiving circuit section 212 receives the first satellite signal from the first GNSS. Further, the second RF receiving circuit section 222 receives the second satellite signal from the second GNSS. The baseband processing circuit section 31 processes the first satellite signal and the second satellite signal. The baseband processing control section 32 controls the operations of the first RF receiving circuit section 212, the second RF receiving circuit section 222, and the baseband processing circuit section 31.

The baseband processing control section 32 includes the first signal processing section 321, the second signal processing section 322, the reception state acquisition section 326, and the processing capacity determination section 327. The first signal processing section 321 performs the reception processing of the first satellite signal. The reception state acquisition section 326 acquires the first reception state including the processing result of the reception processing of the first satellite signal. The processing capacity determination section 327 determines the processing capacity of the reception processing of the second satellite signal depending on the first reception state. The second signal processing section 322 performs the reception processing of the second satellite signal with the processing capacity determined by the processing capacity determination section 327.

According to such a configuration, by supporting the multi-GNSS, power saving can be achieved while improving performance such as improvement of positioning accuracy or expansion of positioning capable area.

In the present embodiment, the first reception state acquired by the reception state acquisition section 326 includes, as the processing result of the reception processing of the first satellite signal, at least one of the number of tracking satellites of the first GNSS, a reception signal intensity index of the first satellite signal, a reception satellite disposition index of the first GNSS, a movement state of the satellite signal receiving device 1, and a positioning state based on the first satellite signal.

According to such a configuration, the processing capacity of the reception processing of the second satellite signal can be determined based on the factors acquired related to the first GNSS, which easily affect the accuracy of the positioning by the first GNSS, and the reception processing of the second satellite signal can be performed with the processing capacity. Further, by using the above factors, it is possible to accurately ascertain the situation in which the positioning accuracy by the first GNSS is expected to be sufficiently high, and it is possible to reduce the processing capacity of the reception processing of the second satellite signal without waste. As a result, the power consumption of the satellite signal receiving device 1 can be further reduced while supporting multi-GNSS.

Further, in the present embodiment, depending on the first reception state acquired by the reception state acquisition section 326, the intermittent drive control section 323 selects either an intermittent drive control with respect to the positioning by the first GNSS or an intermittent drive control with respect to the positioning by both the first GNSS and the second GNSS. In other words, the baseband processing control section 32 selects either the intermittent drive with respect to the first RF receiving circuit section 212 or the intermittent drive with respect to both the first RF receiving circuit section 212 and the second RF receiving circuit section 222, depending on the first reception state.

According to such a configuration, even in a device corresponding to the multi-GNSS, it is possible to accurately switch between the intermittent drive control for positioning by the first GNSS and the intermittent drive control for positioning by the second GNSS depending on the first reception state. Therefore, the power consumption of the satellite signal receiving device 1 can be further reduced while maintaining the positioning performance.

Further, in the present embodiment, when the second satellite signal, which is a target of the decoding processing by the second signal processing section 322, includes the satellite navigation information D1 (first satellite navigation information) and the satellite navigation information D2 (second satellite navigation information) having a transmission speed of navigation information faster than that of the satellite navigation information D1, the baseband processing control section 32 controls the second RF receiving circuit section 222 to be intermittently driven at 100%, which is an example of the first duty ratio. Further, when the second satellite signal does not include the satellite navigation information D2, the baseband processing control section 32 controls the second RF receiving circuit section 222 to be intermittently driven at 50%, which is an example of the second duty ratio lower than the first duty ratio.

According to such a configuration, for example, in an area where a signal including the satellite navigation information D1 can be received but a signal including the satellite navigation information D2 cannot be received, the second RF receiving circuit section 222 can be intermittently driven with a lower duty ratio. As a result, the power consumption of the satellite signal receiving device 1 can be effectively reduced.

Further, the control method of the satellite signal receiving device according to the present embodiment is a control method of a device including the first RF receiving circuit section 212, the second RF receiving circuit section 222, and the baseband processing circuit section 31.

The control method includes step S14 of causing the first RF receiving circuit section 212 to perform reception processing of receiving the first satellite signal from the first GNSS satellite, step S18 of acquiring a first reception state including a processing result of the reception processing of the first satellite signal, step S19 of determining processing capacity of reception processing of the second satellite signal depending on the first reception state, and steps S21, S23, and S27 of causing the second RF receiving circuit section 222 to perform the reception processing of receiving the second satellite signal from the second GNSS satellite with the processing capacity.

According to such a control method, by making the satellite signal receiving device 1 compatible with the multi-GNSS, power saving can be achieved while improving performance such as improvement of positioning accuracy or expansion of positioning capable area.

Further, a program according to the present embodiment is a program that controls the operation of the processor 71 coupled to the first RF receiving circuit section 212, the second RF receiving circuit section 222, and the baseband processing circuit section 31. The program includes causing the first RF receiving circuit section 212 to perform reception processing of receiving the first satellite signal from the first GNSS satellite, acquiring a first reception state including a processing result of the reception processing of the first satellite signal, determining processing capacity of reception processing of the second satellite signal depending on the first reception state, and causing the second RF receiving circuit section 222 to perform the reception processing of receiving the second satellite signal from the second GNSS with the processing capacity.

By executing such a program on the processor 71, the satellite signal receiving device 1 is made compatible with multi-GNSS, and power saving can be achieved while improving performance such as improvement of positioning accuracy or expansion of positioning capable area.

### 4. Electronic Device

Next, an electronic timepiece will be described as an electronic device according to the embodiment.

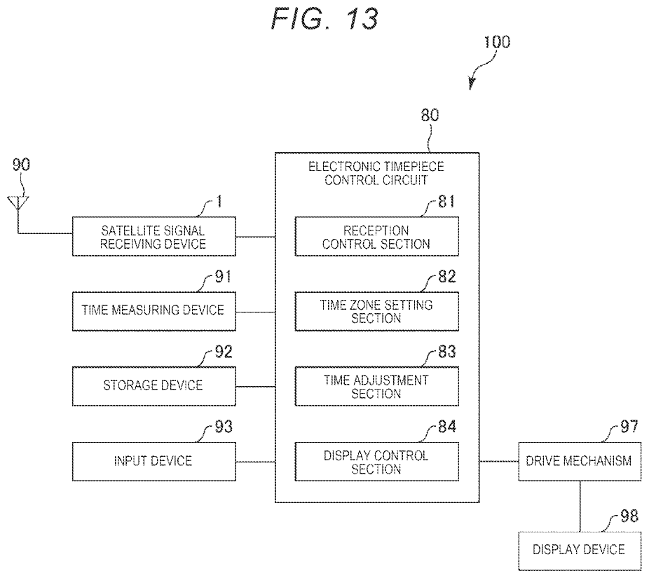

FIG. 13 is a block diagram illustrating a circuit configuration of an electronic timepiece which is an electronic device according to the embodiment.

The electronic timepiece 100 illustrated in FIG. 13 includes the above-mentioned satellite signal receiving device 1, an electronic timepiece control circuit 80, a GNSS antenna 90, a time measuring device 91, a storage device 92, an input device 93, a drive mechanism. 97, and a display device 98.

The satellite signal receiving device 1 is coupled to the GNSS antenna 90 and processes the satellite signal received via the GNSS antenna 90 to acquire time information and position information.

The electronic timepiece control circuit 80 is constituted by a processor that controls an operation of the electronic timepiece 100. The electronic timepiece control circuit 80 functions as a reception control section 81, a time zone setting section 82, a time adjustment section 83, and a display control section 84 by executing various programs stored in the storage device 92.

The reception control section 81 controls the operation of the satellite signal receiving device 1. The time zone setting section 82 sets time zone data based on the position information acquired by the satellite signal receiving device 1. The time adjustment section 83 corrects the time data based on the time information acquired by the satellite signal receiving device 1 and the time zone data set by the time zone setting section 82. The display control section 84 controls the operation of the drive mechanism 97 and controls the display content of the display device 98.

The time measuring device 91 includes, for example, a quartz crystal resonator or the like, and updates the time data by using a reference signal based on an oscillation signal of the quartz crystal resonator.

The input device 93 is constituted by, for example, a button, a crown, or the like, and outputs operation signals thereof to the electronic timepiece control circuit 80.

Although an electronic timepiece has been described above as an example of an electronic device, other examples of the electronic device according to the present disclosure include a wearable terminal, a smartphone, a tablet terminal, a portable navigation device, a car navigation device, a personal computer, or the like.

Although the satellite signal receiving device, the control method of the satellite signal receiving device, the program, and the electronic device according to the present disclosure have been described based on the illustrated embodiment, the present disclosure is not limited to this, and the configuration of each section can be replaced with any configuration having the same function. Moreover, any other components may be added to the embodiment.

What is claimed is:

1. A satellite signal receiving device comprising:
a first RF receiving circuit receiving a first satellite signal from a first GNSS;
a second RF receiving circuit receiving a second satellite signal from a second GNSS;
a baseband processing circuit processing the first satellite signal and the second satellite signal; and
one or more processors configured to control operations of the first RF receiving circuit, the second RF receiving circuit, and the baseband processing circuit, wherein
the one or more processors are configured to execute
performing reception processing of the first satellite signal,
acquiring a first reception state including a processing result of the reception processing of the first satellite signal,
determining processing capacity of reception processing of the second satellite signal depending on the first reception state, and
performing the reception processing of the second satellite signal with the processing capacity.

2. The satellite signal receiving device according to claim 1, wherein
the first reception state includes, as the processing result of the reception processing of the first satellite signal, at least one of the number of tracking satellites of the first GNSS, a reception signal intensity index of the first satellite signal, a reception satellite disposition index of the first GNSS, a movement state of the satellite signal receiving device, and a positioning state based on the first satellite signal.

3. The satellite signal receiving device according to claim 1, wherein
depending on the first reception state, the one or more processors select either an intermittent drive control for the first RF receiving circuit or an intermittent drive control for both the first RF receiving circuit and the second RF receiving circuit.

4. The satellite signal receiving device according to claim 1, wherein
the one or more processors are configured to
intermittently drive the second RF receiving circuit at a first duty ratio when the second satellite signal includes first satellite navigation information and second satellite navigation information having a transmission speed of navigation information faster than that of the first satellite navigation information, and
intermittently drive the second RF receiving circuit at a second duty ratio lower than the first duty ratio when the second satellite signal does not include the second satellite navigation information.

5. A control method of a satellite signal receiving device that includes a first RF receiving circuit receiving a first satellite signal from a first GNSS, a second RF receiving circuit receiving a second satellite signal from a second GNSS, and a baseband processing circuit processing the first satellite signal and the second satellite signal, the control method comprising:
a step of causing the first RF receiving circuit to perform reception processing of receiving the first satellite signal from the first GNSS;
a step of acquiring a first reception state including a processing result of the reception processing of the first satellite signal;
a step of determining processing capacity of reception processing of the second satellite signal depending on the first reception state; and
a step of causing the second RF receiving circuit to perform the reception processing of receiving the second satellite signal from the second GNSS with the processing capacity.

6. A non-transitory computer-readable storage medium storing a program for causing one or more processors that are coupled to a first RF receiving circuit receiving a first satellite signal from a first GNSS, a second RF receiving circuit receiving a second satellite signal from a second GNSS, and a baseband processing circuit processing the first satellite signal and the second satellite signal, the program comprising:
causing the first RF receiving circuit to perform reception processing of receiving the first satellite signal from the first GNSS;
acquiring a first reception state including a processing result of the reception processing of the first satellite signal;
determining processing capacity of reception processing of the second satellite signal depending on the first reception state; and
causing the second RF receiving circuit to perform the reception processing of receiving the second satellite signal from the second GNSS with the processing capacity.

7. An electronic device comprising the satellite signal receiving device according to claim 1.
